(19) United States
(12) Patent Application Publication
(10) Pub. No.: US 2025/0246935 A1
(43) Pub. Date: Jul. 31, 2025

(54) WIRELESS POWER TRANSMISSION APPARATUS

(71) Applicant: Ricky Alora, Tustin, CA (US)

(72) Inventor: Ricky Alora, Tustin, CA (US)

(21) Appl. No.: 18/428,776

(22) Filed: Jan. 31, 2024

(51) Int. Cl. H02J 50/00; H02J 7/00

(52) U.S. Cl. CPC H02J 50/005; H02J 7/0063

(57) ABSTRACT

A wireless power transmission apparatus for wirelessly transmitting power to electronic devices includes a power transmitter assembly and a power reception assembly. The power reception assembly is configured to receive power wirelessly from the power transmitter assembly and has an electrical connector to electrically couple to an electronic device. The power reception assembly has a power storage for storing electrical energy. The power reception assembly can be held in a housed position in the power transmitter assembly and electrically coupled to the power transmitter assembly to receive power through an electrical connection while in the housed position.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to wireless power transmitters and more particularly pertains to a new wireless power transmitter for wirelessly transmitting power to electronic devices.

### (2) Description of Related Art Including Information Disclosed Under 37 CFR 1.97 AND 1.98

The prior art relates to wireless power transmitters, including those that transmit power across rooms or similar distances via radio waves or the like. Various wireless power transmission technologies are known which transmit power wirelessly, including radiative technologies that radiate energy in the forms of visible lasers, microwaves, or the like and nonradiative technologies which couple electrical circuits via magnetic fields or the like. However, the prior art fails to describe an apparatus which arranges wireless power transmission components such that a transmitter assembly selectively houses a receiver assembly, and the receiver assembly is optionally coupled to an electrical port of an electronic device remote from the transmitter assembly. Such an apparatus provides a convenient mechanism for charging electronic devices via an existing electronic port without requiring as much space as other charging devices relying only on bulky batteries.

### (h) Brief Summary of the Invention

An embodiment of the disclosure meets the needs presented above by generally comprising a power transmitter assembly with a transmitter housing that houses a processor and a power transmission circuit. The power transmission circuit is electrically coupled to the processor and is configured for converting energy from an electrical form to an alternative form and transmitting the energy wirelessly. An electrical plug is electrically coupled to the processor and is configured for electrically coupling to an electrical power source. A power reception assembly is configured to wirelessly receive power from the power transmitter assembly. The power reception assembly comprises a receiver housing which houses a power reception circuit that is configured for converting the energy transmitted by the power transmission circuit into an electrical form. An electrical connector is electrically coupled to the power reception circuit and is configured for electrically coupling to an electronic device to charge the electronic device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a bottom perspective exploded view of a wireless power transmission apparatus according to an embodiment of the disclosure.

FIG. 2 is a front view of an embodiment of the disclosure.

FIG. 3 is a rear view of an embodiment of the disclosure.

FIG. 4 is a side view of an embodiment of the disclosure.

FIG. 5 is a cross-section view of an embodiment of the disclosure taken from Arrows 5-5 in FIG. 4.

FIG. 6 is a block diagram of an embodiment of the disclosure.

FIG. 7 is an in-use view of an embodiment of the disclosure.

### (j) DETAILED DESCRIPTION OF THE INVENTION

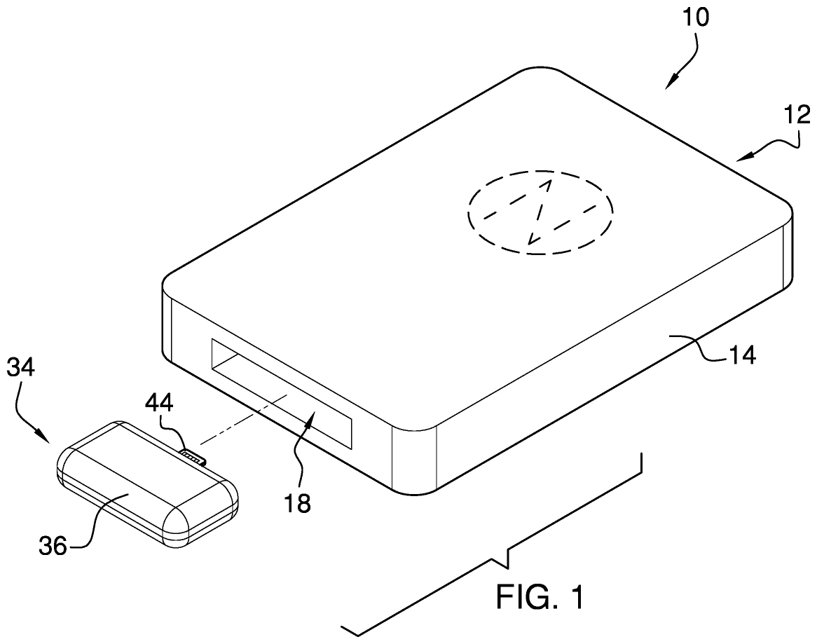

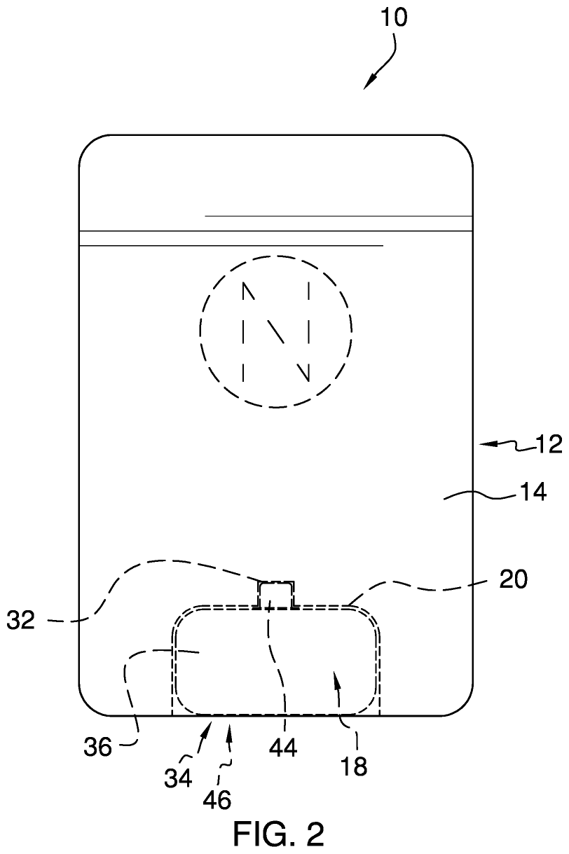

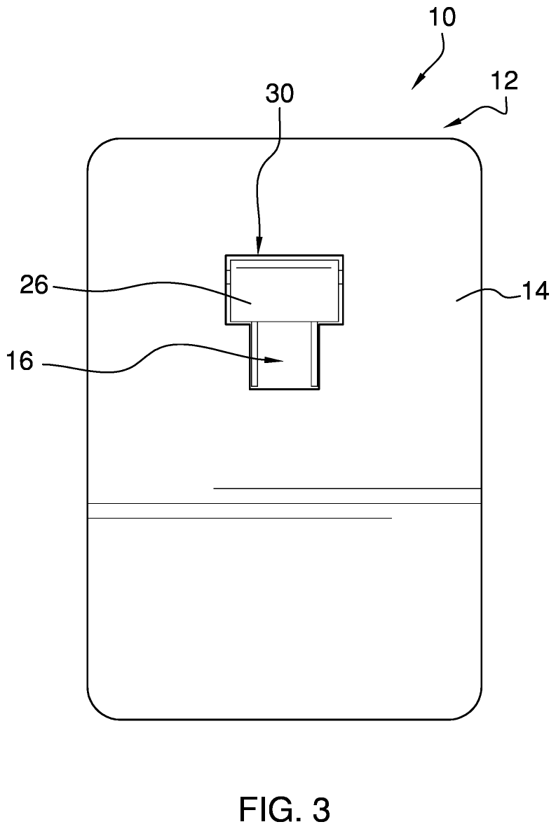

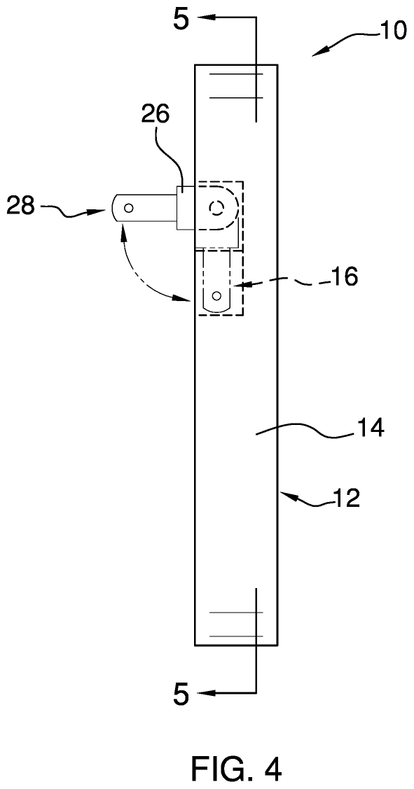

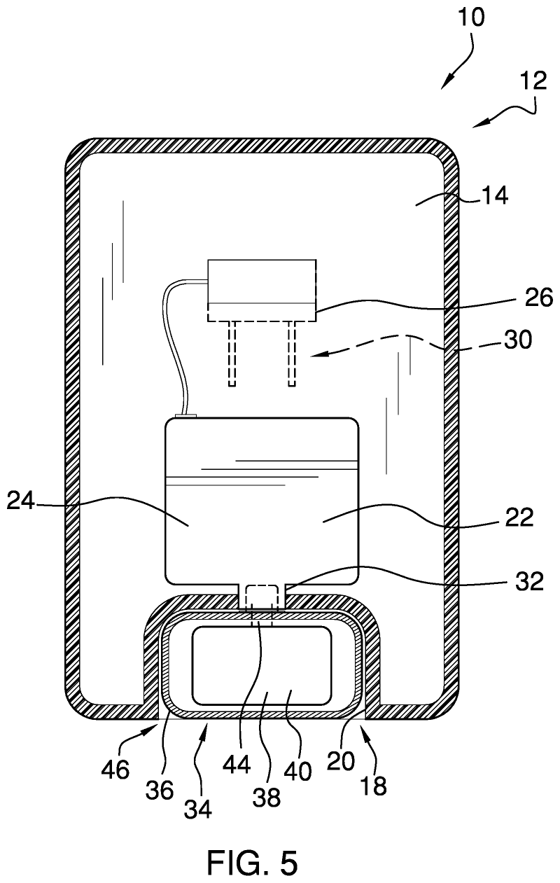

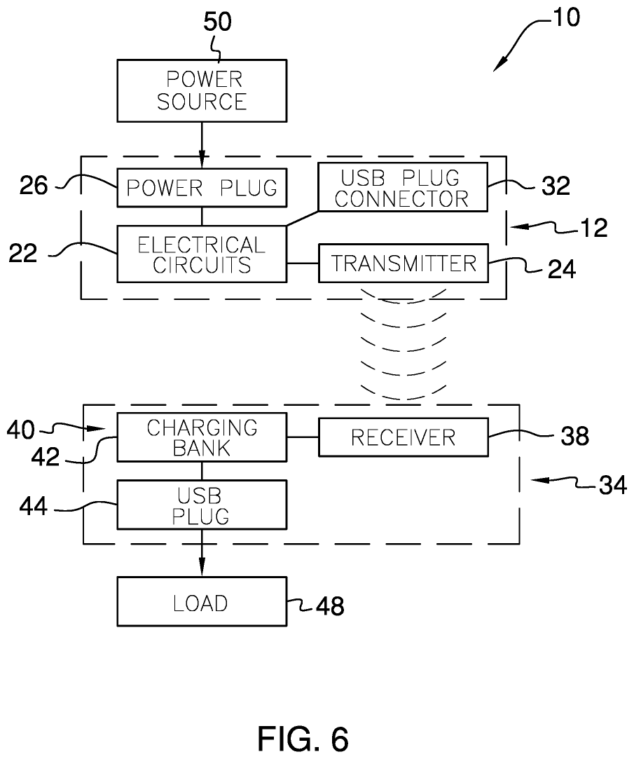

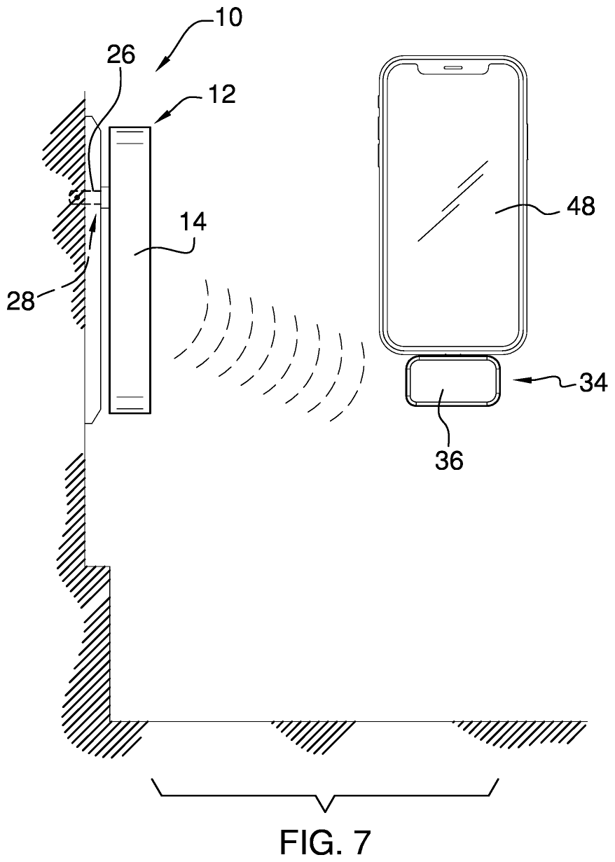

With reference now to the drawings, and in particular to FIGS. 1 through 7 thereof, a new wireless power transmitter embodying the principles and concepts of an embodiment of the disclosure and generally designated by the reference numeral 10 will be described.

As best illustrated in FIGS. 1 through 7, the wireless power transmission apparatus 10 generally comprises a power transmitter assembly 12 with a transmitter housing 14 which houses a processor 20 and a power transmission circuit 22. An electrical plug 24 is electrically coupled to the processor 20 and is configured for electrically coupling to an electrical power source 50. The power transmission circuit 22 is electrically coupled to the processor 20 and is configured for converting energy from an electrical form to an alternative form and transmitting the energy wirelessly. The transmitter housing 14 has a recess 18 which extends therein. An electrical port 30 is electrically coupled to the processor 20 and is positioned on a periphery 20 of the recess 18 of the transmitter housing 14. The electrical plug 24 is movable between a deployed condition 26 and a stored condition 28. The deployed condition 26 includes the electrical plug 24 extending away from the transmitter housing 14, and the stored condition 28 includes the electrical plug 24 being positioned in a cavity 16 positioned within the transmitter housing 14. The electrical plug 24 is pivotally coupled to the transmitter housing 14 but may be slidably coupled or otherwise movably coupled to the transmitter housing 14.

A power reception assembly 34 is configured to wirelessly receive power from the power transmitter assembly 12. The power reception assembly 34 comprises a receiver housing 36 which houses a power reception circuit 38 and a power storage 40. The power reception circuit 38 is configured for converting the energy transmitted by the power transmission circuit 22 into an electrical form and transferring the energy to the power storage 40 to charge the power storage 40. The power storage 40 comprises a battery 42 but may comprise a capacitor or other suitable electrical energy storage. The power storage 40 may in some cases charge energy in other forms (e.g., a flywheel storing kinetic energy) which is readily convertible into electricity.

The power reception assembly 34 further includes an electrical connector 44 which is electrically coupled to the power storage 40. The electrical connector 44 is configured for electrically coupling to an electronic device 48 to charge the electronic device 48. The electronic device 48 may be one of any number of devices such as phones, tablets, computers, headphones, or the like. The electrical connector 44 may be a Universal Serial Bus (USB) type connector, such as a USB-C connector or similar, but any suitable connector may be used.

The receiver housing 36 is positionable in a housed position 46 in the recess 18 of the transmitter housing 14. The electrical connector 44 is insertable into the electrical port 30 of the power transmission assembly to mount the power reception assembly 34 to the power transmission assembly in the housed position 46. While inserted into the electrical port 30, the electrical connector 44 electrically couples the power storage 40 to the processor 20 of the power transmission assembly. In this manner, the processor 20 of the power transmission assembly also charges the power storage 40 through a wired (which is to say electrically connected) manner via the electrical port 30 and the electrical connector 44 when the receiver housing 36 is positioned in the housed position 46. The processor 20 may be configured to sense whether the electrical connector 44 is electrically connected to the electrical port 30 and only charge the power storage 40 via the power transmission circuit 22 and power reception circuit 38 when the electrical connector 44 is electrically disconnected from the electrical port 30. Some embodiments may forego the power storage 40 and transfer electricity directly from the power reception circuit 38 to the electrical connector 44.

The receiver housing 36 of the power reception circuit 38 may also be mountable in other ways to the transmitter housing 14 and may include fasteners such as magnets, hook-and-loop fasteners, snap connections, or the like. The receiver housing 36 has a substantially planar shape such that the receiver housing 36 may lie on a shared plane with electronic devices which are substantially planar in shape such as the typical smart phone when electrically connected to the substantially planar electronic device. In this manner, the receiver housing 36 minimizes obstruction caused by the receiver housing 36 protruding away from such electronic devices.

The power transmission circuit 22 and the power reception circuit 38 may utilize any suitable wireless power transmission technology including inductive coupling, resonant inductive coupling, capacitive coupling, magnetodynamic coupling, microwave emission, and electromagnetic wave transmission. For technologies which require the transmitter to be directed at the receiver in a particular fashion, suitable sensors, actuators, and programming may be employed to orient one or both of the power transmission circuit 22 and the power reception circuit 38 appropriately.

In use, the power transmission circuit 22 is electrically coupled to the electrical power source 50 via the electrical plug 24. The receiver housing 36 may be positioned in the housed position 46 so that the power reception assembly 34 is secured to the power transmission assembly and the power storage 40 is charged via electricity flowing from the electrical power source 50, through the processor 20, through the electrical port 30 and the electrical connector 44, to the power storage 40. The power reception assembly 34 may then be removed from the power transmission assembly and mounted to the electronic device 48 via the electrical connector 44. In this fashion, the power reception assembly 34 is secured to the electronic device 48 and electricity flows from the power storage 40 to power the electronic device 48. The power storage 40 continues to charge via wireless transmission of energy from the power transmission circuit 22 to the power reception circuit 38 using a suitable wireless power transmission technology.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A wireless power transmission apparatus comprising:
a power transmitter assembly comprising:
a transmitter housing;
a processor mounted in the transmitter housing;
an electrical plug electrically coupled to the processor, the electrical plug being configured for electrically coupling to an electrical power source;
a power transmission circuit electrically coupled to the processor and configured for converting energy from an electrical form to an alternative form and transmitting the energy wirelessly; and
a power reception assembly configured to wirelessly receive power from the power transmitter assembly, the power reception assembly comprising:
a receiver housing;
a power reception circuit mounted in the receiver housing, the power receiving circuit being configured for converting the energy transmitted by the power transmission circuit into an electrical form;
an electrical connector electrically coupled to the power reception circuit, the electrical connector being configured for electrically coupling to an electronic device to charge the electronic device.

2. The apparatus of claim 1, wherein the power reception assembly is mountable to the power transmitter assembly.

3. The apparatus of claim 2, wherein the transmitter housing has a recess extending therein, the receiver housing being positionable in a housed position in the recess of the transmitter housing.

4. The apparatus of claim 3, wherein the power transmission assembly further comprises an electrical port positioned on a periphery of the recess of the transmitter housing, the electrical connector of the power reception assembly being insertable into the electrical port of the power transmission assembly to mount the power reception assembly to the transmission assembly in the housed position.

5. The apparatus of claim 4, wherein:
the power reception assembly further comprises a power storage mounted in the receiver housing, being electrically coupled to the power reception circuit such that the power reception circuit is configured to charge the power storage, the power storage electrically coupling the power reception circuit to the electrical port; and
the electrical port of the power transmission assembly is electrically coupled to the processor, the electrical connector of the power reception assembly electrically coupling the power storage of the power reception assembly to the processor of the power transmission assembly when inserted into the electrical port of the power transmission assembly.

6. The apparatus of claim 2, wherein the power transmission assembly further comprises an electrical port, the electrical connector of the power reception assembly being insertable into the electrical port of the power transmission assembly to mount the power reception assembly to the transmission assembly.

7. The apparatus of claim 6, wherein:
the power reception assembly further comprises a power storage mounted in the receiver housing, being electrically coupled to the power reception circuit such that the power reception circuit is configured to charge the power storage, the power storage electrically coupling the power reception circuit to the electrical port; and
the electrical port of the power transmission assembly is electrically coupled to the processor, the electrical connector of the power reception assembly electrically coupling the power storage of the power reception assembly to the processor of the power transmission assembly when inserted into the electrical port of the power transmission assembly.

8. The apparatus of claim 1, wherein the power reception assembly further comprises a power storage mounted in the receiver housing, being electrically coupled to the power reception circuit such that the power reception circuit is configured to charge the power storage, the power storage electrically coupling the power reception circuit to the electrical port.

9. The apparatus of claim 8, wherein the power storage comprises a battery.

10. The apparatus of claim 1, wherein the electrical plug of the power transmission assembly is movable between a deployed condition and a stored condition, the deployed condition including the electrical plug extending away from the transmitter housing, the stored condition including the electrical plug being positioned in a cavity positioned within the transmitter housing.

11. The apparatus of claim 10, wherein the electrical plug is pivotally coupled to the housing.

12. A wireless power transmission apparatus comprising:
a power transmitter assembly comprising:
a transmitter housing, the transmitter housing having a recess extending therein;
a processor mounted in the transmitter housing;
an electrical plug electrically coupled to the processor, the electrical plug being configured for electrically coupling to an electrical power source, the electrical plug being movable between a deployed condition and a stored condition, the deployed condition including the electrical plug extending away from the transmitter housing, the stored condition including the electrical plug being positioned in a cavity positioned within the transmitter housing, the electrical plug being pivotally coupled to the housing;
a power transmission circuit electrically coupled to the processor and configured for converting energy from an electrical form to an alternative form and transmitting the energy wirelessly; and
an electrical port electrically coupled to the processor, the electrical port being positioned on a periphery of the recess of the transmitter housing; and
a power reception assembly configured to wirelessly receive power from the power transmitter assembly, the power reception assembly comprising:
a receiver housing, the receiver housing being positionable in a housed position in the recess of the transmitter housing;
a power reception circuit mounted in the receiver housing, the power receiving circuit being configured for converting the energy transmitted by the power transmission circuit into an electrical form;
a power storage mounted in the receiver housing, the power storage being electrically coupled to the power reception circuit such that the power reception circuit is configured to charge the power storage, the power storage comprising a battery;
an electrical connector electrically coupled to the power storage, the electrical connector being configured for electrically coupling to an electronic device to charge the electronic device, the electrical connector being insertable into the electrical port of the power transmission assembly to mount the power reception assembly to the power transmission assembly in the housed position, the electrical connector electrically coupling the power storage to the processor of the power transmission assembly when inserted into the electrical port of the power transmission assembly.
